(19) United States
(12) Patent Application Publication
(10) Pub. No.: US 2026/0087050 A1
(43) Pub. Date: Mar. 26, 2026

(54) SYSTEMS AND METHODS FOR TWO-STEP RETRIEVAL AUGMENTED GENERATION

(71) Applicant: U.S. Bancorp, National Association, Minneapolis, MN (US)

(72) Inventors: Giacomo Domeniconi, New York, NY (US); Kai-min Kevin Chang, San Mateo, CA (US); Samuel Assefa, Watertown, MA (US)

(73) Assignee: U.S. Bancorp, National Association, Minneapolis, MN (US)

(21) Appl. No.: 18/895,287

(22) Filed: Sep. 24, 2024

(51) Int. Cl. G06F 16/33; G06F 16/383

(52) U.S. Cl. CPC G06F 16/3344; G06F 16/3347; G06F 16/383

(57) ABSTRACT

A method includes receiving, by one or more processors, a natural language query, executing, by the one or more processors, a first large language model (LLM) using as input the natural language query to generate a preliminary response to the natural language query, executing, by the one or more processors, a machine learning model using as input the preliminary response to generate a preliminary response embedding, querying, by the one or more processors, a vector database using the preliminary response embedding to retrieve contextual data for the natural language query, and executing, by the one or more processors, a second LLM using as input the natural language query and the contextual data to generate a response to the natural language query.

### BACKGROUND

Retrieval augmented generation uses a vector database to provide context to large language models (LLMs) to generate context-driven responses. The vector database can include embeddings generated using domain-specific data to provide domain-specific context to the LLMs during response generation.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates an example system for two-step retrieval augmented generation (RAG), in accordance with an implementation;

FIG. 2 illustrates a block diagram of an example system for two-step RAG, in accordance with an implementation;

FIG. 3 illustrates an example method for two-step RAG, in accordance with an implementation;

FIG. 4 discloses a computing environment in which aspects of the present disclosure may be implemented, in accordance with an implementation; and

FIG. 5 illustrates an example machine learning framework that techniques described herein may benefit from.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

As mentioned above, RAG can be used to provide context-driven responses to queries. However, the contextual data retrieved during RAG is highly dependent upon the information used to query the vector database. Often, queries include language that does not match language used in relevant domain data, resulting in irrelevant or incorrect contextual data. Using incorrect contextual data can result in responses to queries that appear sound, but are incorrect, and/or responses that are highly confusing, abstract, or ambiguous.

A computer implementing the systems and methods described herein can address these technical problems using a two-step RAG method. To do so, the computer can first execute an LLM using as input a natural language query to generate a preliminary response. The computer can use the preliminary response as input to a machine learning model (e.g., a machine learning model separate from the LLM) to generate a preliminary response embedding. The computer can then use the preliminary response embedding, in some cases with the initial natural language query, to query the vector database to generate a response to the natural language query. By generating a response in this away (e.g., as opposed to only using the natural language query to query the vector database), the computer can reduce the effect that ambiguity, awkward phrasing, and incorrect or misleading terms in the initial natural language query can have on generating an accurate and/or precise responses. For instance, the preliminary response can normalize the initial query to reduce the ambiguity or misleading terms that may have been in the initial natural language query such that the LLM does not use the ambiguity or misleading terms to retrieve incorrect or irrelevant contextual data from the vector database.

Another problem that the two-step response generation technique described herein overcomes is that there is typically a mismatch between the form of typical natural language queries and domain data retrieved from a vector database. For instance, while most natural language queries take the form of a question, most domain data takes the form of declarative statements, leading to a mismatch in the form of queries and domain data, further complicating the retrieval of relevant contextual data from the vector database. By implementing the systems and methods described herein, the computer can reduce this problem by first executing the LLM using as input the query to generate the preliminary response and then using the preliminary response to query the vector database. The two-step process can allow for alignment of the form of the preliminary response with the form of the domain data (declarative statement, formal tone, etc.) which results in retrieval of more contextually relevant data.

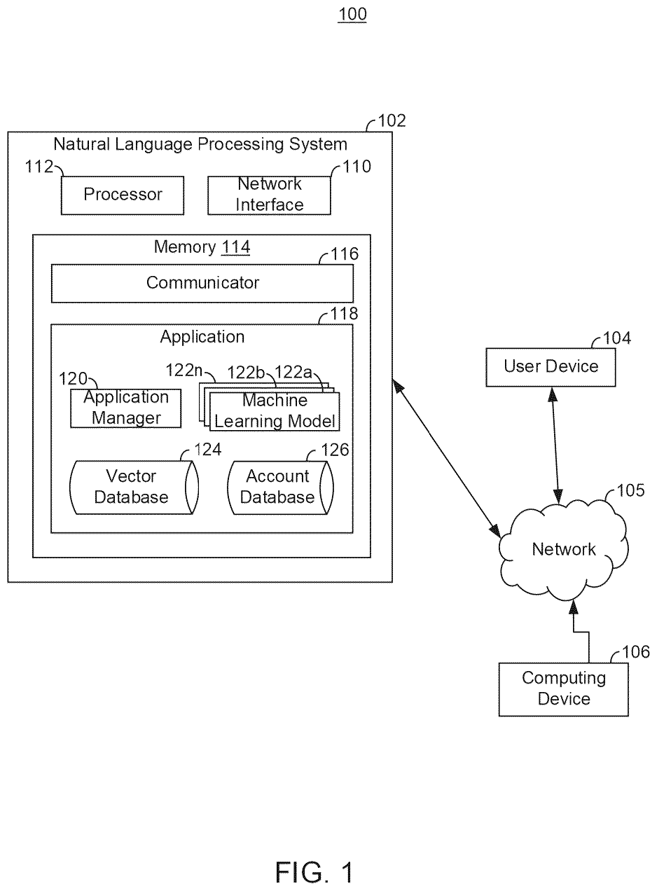

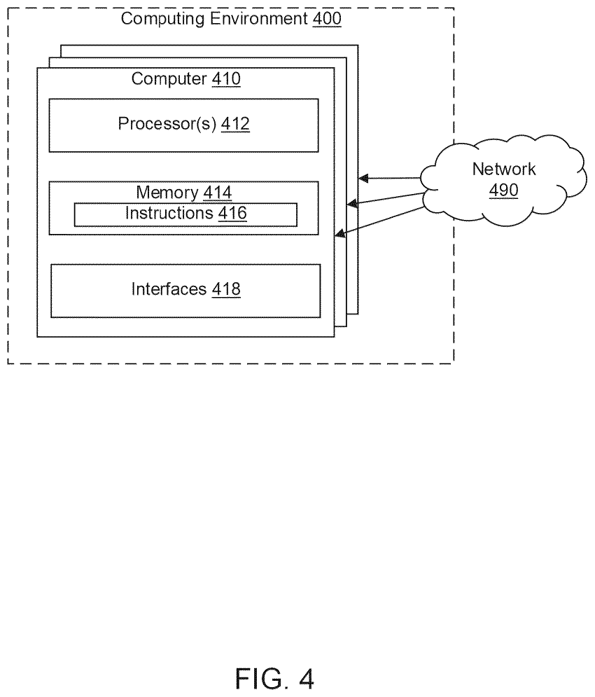

For example, FIG. 1 illustrates an example system 100 for two-step retrieval augmented generation (RAG) to generate responses to natural language queries, in accordance with an implementation. In brief overview, the system 100 can include a natural language processing system 102, a user device 104, and a computing device 106. The natural language processing system 102, the user device 104, and/or the computing device 106 can each include one or more aspects or features described elsewhere herein, such as in reference to the computing environment 400 of FIG. 4. The natural language processing system 102 can be configured to execute an application 118 stored locally on the natural language processing system 102 to generate responses to natural language queries. The natural language processing system 102 can generate preliminary response embeddings based on individual natural language queries and then use the preliminary response embedding to retrieve domain data from a vector database to use to generate a response. In doing so, the system 100 can generate, accurate responses to natural language queries using contextual data that can ground the responses in a particular domain. The system 100 may include more, fewer, or different components than shown in FIG. 1.

The natural language processing system 102, the user device 104, and/or the computing device 106 can include or execute on one or more processors or computing devices and/or communicate via a network 105. The network 105 can include computer networks such as the Internet, local, wide, metro, or other area networks, intranets, satellite networks, and other communication networks, such as voice or data mobile telephone networks. The network 105 can be used to access information resources such as web pages, websites, domain names, or uniform resource locators that can be presented, output, rendered, or displayed on at least one computing device (e.g., the natural language processing system 102, the user device 104, and/or the computing device 106), such as a laptop, desktop, tablet, personal digital assistant, smartphone, portable computer, or speaker.

The natural language processing system 102, the user device 104, and/or the computing device 106 can include (e.g., each include) or utilize at least one processing unit or other logic devices such as a programmable logic array engine or a module configured to communicate with one another or other resources or databases. As described herein, computers can be described as computers, computing devices, user devices, or client devices. The natural language processing system 102, the user device 104, and/or the computing device 106 may each contain a processor and a memory. The components of the natural language processing system 102, the user device 104, and/or the computing device 106 can be separate components or a single component. The system 100 and its components can include hardware elements, such as one or more processors, logic devices, or circuits.

The natural language processing system 102, the user device 104, and/or the computing device 106 can each be an electronic computing device (e.g., a cellular phone, a laptop, a tablet, or any other type of computing device). The natural language processing system 102, the user device 104, and/or the computing device 106 can each include a display with a microphone, a speaker, a keyboard, a touchscreen, or any other type of input/output device.

Users can access a platform provided by the natural language processing system 102 and/or the computing device 106 through the user device 104, and/or the computing device 106 to submit natural language queries and receive responses. In one example, a user of the user device 104 can provide an input into the computing device 106 including a natural language query. The computing device 106 can execute an application to submit (e.g., send or submit) the natural language query to the natural language processing system 102. The computing device 106 can transmit a response generated by the natural language processing system 102 to the user device 104.

The user device 104 can access the platform hosted by the computing device 106 or natural language processing system 102 that is configured to manage an account with an associated entity. Through the application, the user device 104 can submit natural language queries to the natural language processing system 102. The natural language processing system 102 can access a vector database 124 and an account database 126. The vector database 124 may include embeddings representing information associated with the platform. The account database 126 may include account information of an account of the user. In some implementations, the vector database 124 includes embeddings generated using information of the account of the user. Accordingly, the responses to the natural language queries can be guided (e.g., informed, refined, constrained) by the information associated with the platform and/or the information of the account of the user. The user device 104 can receive the responses to the natural language queries. Thus, the natural language processing system 102 can generate individualized responses to natural language queries.

The natural language processing system 102 may comprise one or more processors that are configured to receive natural language queries and execute one or more machine learning models to generate responses to the natural language queries. The natural language processing system 102 may comprise a network interface 110, a processor 112, and/or memory 114. The natural language processing system 102 may communicate with the computing device 106 and/or the user device 104 via the network interface 110, which may be or include one or more antennas or other network devices that enables communication across a network and/or with other devices. The processor 112 may be or include an ASIC, one or more FPGAs, a DSP, circuits containing one or more processing components, circuitry for supporting a microprocessor, a group of processing components, or other suitable electronic processing components. In some embodiments, the processor 112 may execute computer code or modules (e.g., executable code, object code, source code, script code, machine code, etc.) stored in memory 114 to facilitate the activities described herein. The memory 114 may be any volatile or non-volatile computer-readable storage medium capable of storing data or computer code.

The memory 114 may include a communicator 116 and an application 118. The application 118 can include an application manager 120, machine learning models 122a-n (individually machine learning model 122, and, in groups, machine learning models 122), a vector database 124, and/or an account database 126. In brief overview, the components 116-124 may receive a first natural language query from the user device 104 and use the machine learning models 122 to generate a response. The components 116-122 can execute a first machine learning model to generate a preliminary response to the natural language query, execute a second machine learning model to generate an embedding from the preliminary response, use the vector database 124 to retrieve contextual information using the preliminary response embedding (e.g., based on access parameters stored in the account database 126), and execute a third machine learning model using the natural language query and the contextual information to generate the response to the natural language query. In this way, the natural language processing system 102 can generate more accurate responses to natural language queries and/or take into account contextual data regarding information of the platform and/or information of the account of the user.

The vector database 124 can be or include a relational database or a graphical database. The vector database 124 can include embeddings generated using information associated with the platform and/or information associated with the account of the user. The information associated with the platform (otherwise referred to as domain data) can be obtained from a separate computing system, such as a server. In an example, the domain data can be sourced from a website associated with the platform. In an example, the domain data can include documents related to the platform. The domain data can be restricted to certain groups of users. Thus, when generating responses to the natural language queries, the natural language processing system 102 can determine the portion of the vector database 124 from which to retrieve contextual information, or which retrieved contextual information to use in generate the responses.

The natural language processing system 102 can generate the embeddings and store the embeddings in the vector database 124 over time. For example, the natural language processing system 102 can receive domain data from the computers and/or servers associated with the platform as the domain data is generated. In an example, as a website associated with the platform is updated, the natural language processing system 102 can use the updates to the website to generate embeddings that are stored in the vector database 124. In an example, as documents related to the platform are generated or stored, the natural language processing system 102 can use the documents to generate embeddings that are stored in the vector database 124.

The natural language processing system 102 may use a semantic machine learning model of the machine learning models 122 to generate the embeddings stored in the vector database 124. The semantic machine learning model may be used to generate the embeddings stored in the vector database 124 and to generate embeddings used to query the vector database 124. In an example, the semantic machine learning model is used to generate the embeddings in the vector database and is used to generate a query embedding in order to search the vector database 124 for embeddings that are similar to, or nearest to, the query embedding. In this way, information can be used consistently (using the same semantic machine learning model) to generate embeddings, allowing for the retrieval of relevant contextual information from the vector database 124.

The account database 126 can be or include a relational or graphical database configured to store data (e.g., account data) for different accounts. The account database 126 can store records (e.g., tables or data structures) for each account that includes data for the account. The account data can include, for example, name, age, gender, time the account has been open, subscription information if the account is a subscription, etc. Each record can include one or more field-value pairs that each correspond to a different type of data.

The communicator 116 may comprise programmable instructions that, upon execution, cause the processor 112 to communicate with the user device 104, the computing device 106, and/or any other computing device. The communicator 116 can be or include an application programming interface (API) that facilitates communication between the natural language processing system 102 (e.g., via the network interface 110 of the natural language processing system 102) and other computing devices. The communicator 116 may communicate with the user device 104, the computing device 106, and/or any other computing devices across a network (e.g., the network 105).

In one example, the communicator 116 can establish a connection with a computing device (e.g., the user device 104 or the computing device 106). The communicator 116 can establish the connection with the computing device over the network 105. To do so, the communicator 116 can communicate with the computing device across the network 105. In one example, the communicator 116 can transmit a syn packet to the computing device 106 (or vice versa) and establish the connection using a TLS handshaking protocol. The communicator 116 can use any handshaking protocol to establish a connection with the computing device 106. The natural language processing system 102 can communicate with the computing device 106 over the established connection.

The application 118 may comprise programmable instructions that, upon execution, cause the processor 112 to facilitate communication with the user device 104 to enable a user to access the platform. In some embodiments, the application 118 can be an API and be a part of or include the communicator 116. The application 118 can generate user interfaces with data from the computing device 106 and present the user interfaces on a display of the natural language processing system 102. In some cases, the application 118 can use machine learning models or machine learning techniques to generate and/or select a response to a natural language query to include in a user interface and present the user interface on the display. The computing device 106 can receive the response and include the response in the user interface for display on the user device 104.

The application manager 120 of the application 118 can receive the natural language queries from the user device 104 and/or the computing device 106. The application manager 120 may comprise programmable instructions that, upon execution, cause the processor 112 to perform different operations using the application 118, such as receiving natural language queries, using the machine learning models 122 to generate responses to the natural language queries, using the machine learning models 122 to evaluate the responses, and providing the responses to the user device 104 and/or the computing device 106. The application manager 120 can communicate or interact with the computing device 106 to transmit and/or receive data for an account of a user accessing the natural language processing system 102.

The application manager 120 can manage the machine learning models 122. In doing so, the application manager 120 can facilitate reception and/or retrieval of the machine learning models 122 from other computing devices. For example, the application manager 120 can receive the machine learning models 122a and 122b from the computing device 106. The application manager 120 can receive or retrieve the machine learning models 122a and 122b from the computing device 106 in response to updates to the domain data. In an example, the machine learning models 122 include a large language model (LLM) that is fine-tuned using the domain data. In some implementations, when the domain data is updated, the LLM is updated using the updated domain data. The application manager 120 can retrieve the updated LLM and/or updated weights for the LLM such that the fine-tuning of the LLM reflects the updated domain data. The application manager 120 can also manage machine learning models local to the natural language processing system 102, such as by facilitating the creation, updating, use, and destruction of such models as relevant.

The machine learning models 122 may each be or include a neural network, a support vector machine, a random forest, a large language model, or any other type of machine learning model. The machine learning models 122 may be or include models that are each configured to perform different actions in a cascade for generating responses to natural language queries. As discussed herein, a first machine learning model (e.g., LLM) may generate a preliminary response to a natural language query, a second machine learning model (e.g., semantic model or a neural network) may generate an embedding using the preliminary response, and a third machine learning model (e.g., LLM) may generate a response to the natural language query using the natural language query and contextual data retrieved from the vector database 124 using the embedding generated using the preliminary response. One or more of the machine learning models 122 may have been trained at other computing devices prior to being transmitted to the natural language processing system 102. In an example, the LLMs used by the natural language processing system 102 may be pre-trained LLMs and/or general-purpose LLMs. In this way, the natural language processing system 102 can use the contextual data to generate meaningful, accurate responses to natural language queries using off-the-shelf, pre-trained LLMs. The application manager 120 may further train one or more of the machine learning models 122 locally after receiving the machine learning models 122. In an example, the application manager 120 may fine-tune an LLM using the domain data.

The application manager 120 may use the machine learning models 122 to generate responses to natural language queries for the user accessing the natural language processing system 102. For example, the user can access the application 118 through an account that the user has with the application 118. The user can provide an input (e.g., via an input/output device, such as a mouse, keyboard, or touch screen) into the web page or user interface including one or more natural language queries. The application manager 120 can receive the input as a request for generation of responses to the one or more natural language queries using the machine learning models 122. Responsive to the request, the application manager 120 can retrieve the machine learning models 122 from memory. The application manager 120 can execute the machine learning models 122 using an account identifier of the user account associated with the user accessing the natural language processing system 102 to generate responses to the one or more natural language queries.

In some implementations, the application manager 120 may be configured to generate a user interface on the display of the natural language processing system 102 and/or the user device 104. The user interface may be or include one or more fields for submitting natural language queries and displaying responses. A user accessing the natural language processing system 102 and the application 118 through an account associated with (e.g., owned by) the user can provide input in the one or more fields (e.g., a chat interface) to submit natural language queries to the natural language processing system 102. Responsive to the input, the application manager 120 can execute the machine learning models 122 to generate responses to the natural language queries.

The application manager 120 may use the account identifier of the account through which the user is accessing the application 118 to generate responses to natural language queries from the user device 104. For example, the application manager 120 may query the account database 126 using the account identifier as a key to identify characteristics and/or permissions of the account. The application manager 120 may retrieve account data of the account based on the query. The application manager 120 can use the account data as contextual data. The application manager 120 can use the account data to restrict queries to the vector database 124 to domain data that the user is authorized to access. The application manager 120 can use the account data to restrict use of contextual data retrieved from the vector database 124 in generated responses to natural language queries. In an example, an LLM generates a preliminary response to a query (e.g., a natural language query) received from a client device or computing device. The application manager 120 can execute a machine learning model 122 to generate a preliminary response embedding. The application manager 120 can use the preliminary response embedding to query the vector database 124 to retrieve contextual data. In this example, the account data is used to restrict what contextual data is provided to a second LLM for generating a response based on the user having access to some of the contextual data but not all of the contextual data.

Responsive to retrieving the contextual data, the application manager 120 can execute an LLM (e.g., the same LLM that generated the preliminary response or a different LLM) using the contextual data as input to generate a response to the query. In some cases, the application manager 120 can include the query with the contextual data in the input to the LLM. The execution can cause the LLM to generate a response to the query based on the contextual data and/or the initial query. The application manager 120 can present or display the response on the user interface or display of the client device or computing device that submitted the natural language query.

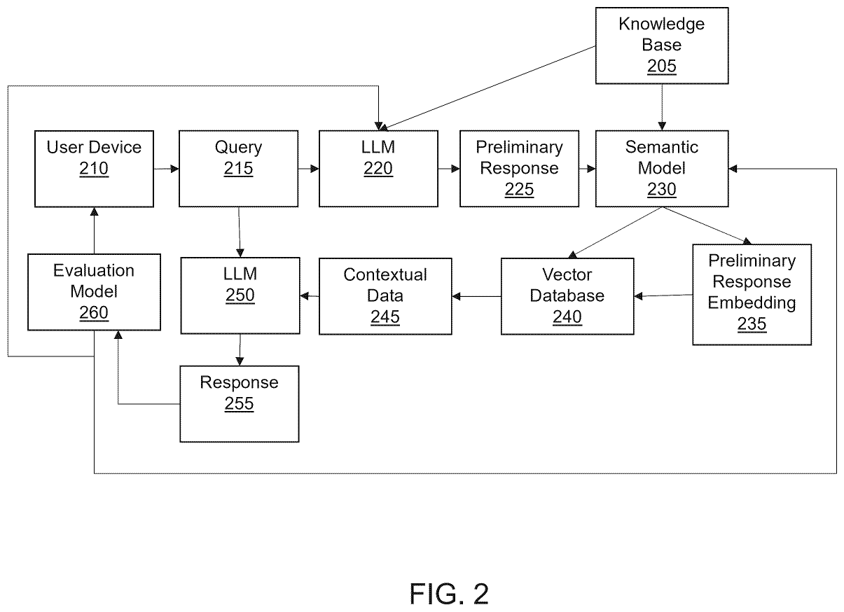

FIG. 2 illustrates a block diagram of an example system 200 for two-step RAG, in accordance with an implementation. The system 200 may be similar to the system 100 of FIG. 1. Components of the system 200 may correspond to components of the system 100 of FIG. 1. In an example, a user device 210 may correspond to the user device 104 of FIG. 1. In an example, a first LLM 220, a semantic model 230, and a second LLM 250 may correspond to the machine learning models 122 of FIG. 1. In an example, everything illustrated in the system 200, in some cases other than the user device 104, may correspond to the natural language processing system 102 of FIG. 1. The system 200 may be implemented using the computing environment 400 of FIG. 4.

The user device 210 provides a query 215 to the first LLM 220. The query 215 may be a natural language query. The first LLM 220 may be a pre-trained LLM, a general-purpose LLM, and/or an LLM that is fine-tuned using domain data. In an example, the first LLM 220 is fine-tuned using domain data from a knowledge base 205 to generate responses based on the domain data and specific to the domain. The first LLM 220 executes, using as input the query 215, to generate a preliminary response 225. The preliminary response 225 may be a response to the query 215. The preliminary response 225 may be a natural language response to the query 215. In some implementations, the preliminary response 225 is provided to the user device 210 for the user to indicate whether the preliminary response 225 is accurate. In some implementations, the preliminary response 225 may be generally accurate, but not domain-accurate, such that the preliminary response 225 does not include or is not based on domain data.

The semantic model 230 can be executed using as input the preliminary response 225 to generate a preliminary response embedding 235. The preliminary response embedding 235 may be a representation of features of the preliminary response. The preliminary response embedding 235 may be a feature vector, or semantic vector that represents semantic features of the preliminary response 225. The semantic model 230 may also be referred to as an embedding model, as it generates embeddings based on input, such as the preliminary response 225.

The semantic model 230 provides the preliminary response embedding 235 to a vector database 240. The vector database 240 includes a plurality of embeddings. The vector database 240 may compare the preliminary response embedding 235 to the plurality of embeddings to identify embeddings that are similar to the preliminary response embedding 235. In some implementations, the vector database 240 determines distances between the preliminary response embedding 235 and the plurality of embeddings and identifies similar embeddings to the preliminary response embedding 235 as embeddings that are within a threshold distance from the preliminary response embedding 235.

The plurality of the embeddings in the vector database 240 may be generated by the semantic model 230. The plurality of embeddings may be generated by executing the semantic model 230. The plurality of embeddings may be generated by executing the semantic model 230 using as input domain data from the knowledge base 205. The knowledge base 205 may include a database, website, server, document repository, or other data source including the domain data. The domain data may be data related to a specific domain, such as a particular field of knowledge, data stored within a secure computing environment, data associated with a particular platform, data corresponding to a particular transaction or application, and/or other types of data unified by a common theme. In an example, the domain data is data sourced from a company's website, databases, and documents, such that the domain data represents information from and about the company. In an example, the domain data is data regarding a computer application, such as documentation of the computer application, user guides for the computer application, and/or source code for the computer application. The semantic model 230 may be executed using the domain data from the knowledge base 205 such that the vector database 240 includes embeddings representing the domain data. In this way, the vector database 240 can be queried using an embedding generated by the semantic model 230 to retrieve embeddings and corresponding domain data that are similar to the embedding, and the input used to generate the embedding.

The vector database 240 identifies embeddings close to the preliminary response embedding 235 to identify domain data in the knowledge base 205 that is similar to the preliminary response 225. The vector database 240 can retrieve the identified domain data from the knowledge base 205 and provide the identified domain data as contextual data 245 for the query 215. The contextual data 245 may provide context for the query 215 to improve an accuracy and relevance of a response to the query 215. In an example, the contextual data 245 includes a webpage containing information relevant to the query 215. In an example, the contextual data 245 includes a spreadsheet containing data relevant to the query 215. In an example, the contextual data 245 includes text from a document that is relevant to the query 215. In some implementations, the contextual data 245 includes summaries of relevant domain data from the knowledge base 205. In an example, the first LLM 220 and/or the second LLM 250 are executed using as input the identified domain data to generate summaries of the identified domain data, which summaries are included in the contextual data 245.

The second LLM 250 can be executed using as input the query 215 and the contextual data 245 to generate a response 255. The response 255 may be similar to the preliminary response 225 except that the response 255 is generated using the contextual data 245. The response 255 may be very different from the preliminary response 225, as the contextual data 245 guides the second LLM 250 to respond differently than if the contextual data 245 were not used.

One technical advantage of querying the vector database 240 using the preliminary response embedding 235 is that domain data from the knowledge base 205 is closer in the embedding space (e.g., has shorter distances from in the embedding space) to the preliminary response 225 than to the query 215. In some implementations, the preliminary response 225 is closer to the domain data in the embedding space than the query 215 as the query 215 is in the form of a question while the preliminary response 225 is in the form of a declarative statement. Thus, if the domain data in the knowledge base 205 contains more declarative statements than questions, the preliminary response 225 is closer to the domain data in the embedding space than the query 215. In many implementations, the domain data will include many more declarative statements than questions. Furthermore, the preliminary response 225 may include terms found in the domain data that are not found in the query 215, further decreasing a distance in the embedding space between the preliminary response 225 and the plurality of embeddings relative to the query. In an example, the query 215 includes the question: “How do I get the current database status?” In this example, the preliminary response 225 may be “Database status can often be determined by making an API call to the database, or to a database administration service. The format of the database status API call can depend on the type of API used, such as REST, and destination of the database status API call.” In this example, the domain data includes documentation of database status API calls, REST calls, and the destination of the database status API call, which terms are not found in the query 215 but are found in the preliminary response 225. In this example, querying the vector database 240 using the preliminary response 225 will retrieve contextual data that is much more relevant than querying the vector database 240 using the query 215.

Furthermore, querying the vector database 240 using the preliminary response 225 addresses the technical problems posed by natural language queries that are hyper-specific or overly broad. Querying the vector database 240 with hyper-specific queries may result in retrieval of contextual data that is incorrect or irrelevant, as words in the queries cause domain data including similar words to be retrieved that is not relevant to the query. Querying the vector database 240 with overly broad queries can also cause the vector database 240 to return irrelevant domain data, as the overly broad queries give little to no guidance as to what is actually relevant. Thus, by first executing the LLM 220 using the query 215 to generate the preliminary response 225, executing the semantic model 230 using the preliminary response to generate the preliminary response embedding 235, and querying the vector database 240 using the preliminary response embedding 235, the range of acceptable specificity in queries received from the user device 210 is broadened. Stated otherwise, queries of a broader range of specificity can be used to retrieve relevant contextual data.

Querying the vector database 240 using the preliminary response 225 addresses the technical problems posed by natural language queries that are complex or that include compound questions. By allowing the first LLM 220 to generate the preliminary response 225, the complexity of the query 215 can be broken down into chunks that result in more relevant contextual data than the query 215. In an example, a question like “what is the impact of inflation on stock market performance and how does it vary across sectors” can be broken down by the first LLM 220 into different segments of the preliminary response 225 that address how inflation affects stock market performance and how inflation impact varies across market sectors. These different segments in the preliminary response 225, when used by the semantic model 230 to generate the preliminary response embedding, allow for the encoding of more relevant information than would be encoded in an embedding generated by the semantic model 230 using the compound, complex query 215.

Querying the vector database 240 using the preliminary response 225 addresses the technical problems posed by natural language queries that include abbreviations and acronyms. The first LLM 220 may respond to the query 215 including an acronym with the preliminary response 225 including a long form or explanation of the acronym, allowing for encoding the long form or explanation of the acronym in the preliminary response embedding 235, resulting in more relevant contextual data than the acronym along. In an example, a query such as “what is APR?” may result in a preliminary response such as “APR stands for annual percentage rate, which is the annual rate charged for borrowing or made by investing.” The resulting preliminary response embedding includes more relevant data than the query, resulting in more relevant contextual data.

Querying the vector database 240 using the preliminary response 225 addresses the technical problems posed by natural language queries that use a different tone than the domain data in the knowledge base 205. For example, if the domain data has a formal tone, a query in an informal tone may use different language than is used in the domain data, reducing a likelihood of relevant contextual data being retrieved from the vector database 240. Similarly, if the domain data has an informal tone, a query in a formal tone may use different language than is used in the domain data, reducing a likelihood of relevant contextual data being retrieved from the vector database 240. In some implementations, an embedded prompt may be used to prompt the first LLM 220 to match the general tone of the domain data. In an example, a query such as “how come stocks go up and down” might be used as input to the first LLM 220 with a prompt to use a formal tone to generate a preliminary response of “market supply and demand regulate the fluctuation of stock prices.” In this example, if the domain data discusses concepts such as “fluctuation of stock prices” and “supply and demand,” the preliminary response will result in much more relevant contextual data than the query.

Querying the vector database 240 using the preliminary response 225 addresses the technical problems posed by natural language queries that assume knowledge of prior conversation context. While the first LLM 220 can handle this assumption quite well, the vector database 240 may be unequipped to retrieve contextual data based on a conversational context. In an example, a query during a conversation regarding financial portfolios may take the form of “what's the risk,” which query would most likely result in irrelevant contextual data if used to query the vector database 240. However, the first LLM 220 can generate a preliminary response of “the risk of a financial portfolio depends on the types of investments it contains” based on the conversational context, which preliminary response would be much more likely than the query to result in relevant contextual information.

In some implementations, the first LLM 220 and the second LLM 250 are the same LLM. In some implementations, the first LLM 220 and the second LLM 250 are based on the same LLM, where fine-tuning is applied to one or more of the first LLM 220 and the second LLM 250. In an example, the first LLM 220 and the second LLM 250 are two instances of a same LLM, and the first LLM 220 is fine-tuned using the domain data in the knowledge base 205. In this way, a quality (accuracy, relevance, etc.) of the preliminary responses 225 is improved. In this example, the second LLM 250 is not fine-tuned using the domain data such that the response 255 is generated using only the provided contextual data 245. In this way, leakage of the domain data can be prevented, as an LLM fine-tuned using the domain data may reveal the domain data. As discussed herein, the contextual data 245 can be restricted based on user permissions or authorizations of the user of the user device 210. In an example, if a user is authorized to access the contextual data 245, the contextual data 245 is provided as input to the second LLM 250. In an example, if the user is authorized to access only a portion of the contextual data 245, only the authorized portion of the contextual data 245 is provided to the second LLM 250. In this way, user access authorization can be enforced such that the second LLM 250 does not have access to and can thus not leak domain data to which the user does not have authorized access. Additionally, using an LLM that is not fine-tuned using the domain data as the second LLM 250, explanations for the response 255 can be more readily generated, as the domain data available to the second LLM 250 is restricted to the contextual data 245.

In some implementations, the response 255 is provided to the user device 210. In some implementations, the response 255 is provided to an evaluation model 260. The evaluation model 260 can be a machine learning model. In some implementations the evaluation model 260 is the first LLM 220 and/or the second LLM 250. In an example, the evaluation model 260 includes an ensemble of machine learning models that each evaluate the response (e.g., generate a score for the response), where the output of the evaluation model 260 is a weighted output of the ensemble of machine learning models. The evaluation model 260 may be executed using as input the response 255 to generate an accuracy score for the response. The accuracy score may represent how accurately the response 255 addresses the query 215. The evaluation model 260 can compare the accuracy score for the response 255 to a predetermined accuracy threshold. If the accuracy score is above the predetermined accuracy threshold, the evaluation model 260 provides the response to the user device 210. If the accuracy score is below the predetermined accuracy threshold, the evaluation model 260 can provide the response 255 to the user device 210 for user feedback, provide the response 255 to the first LLM 220 as input, and/or provide the response 255 as input to the semantic model 230. While various examples and implementations are described herein relative to an accuracy score, different evaluation scores for the response 255 are contemplated, such as a relevance score, a factualness score, a desirability score (e.g., aligning with data security or response format requirements), or any combination thereof.

The user of the user device 210 can indicate whether the response 255 is accurate, whether the response 255 is factual, whether the response is relevant, and/or whether the response 255 adequately responds to the query 215. If the user indicates that the response 255 is unsatisfactory in any regard, the evaluation model 260 can provide the response 255 to the first LLM 220 and/or the semantic model 230 as input. In some implementations, the response 255, as provided to the user device 210 includes an indication of any evaluation scores generated for the response 255. In some implementations, the evaluation model 260 modifies the response 255 to include the evaluation scores.

The first LLM 220 can be executed using as input the response 255. In some implementations, the first LLM 220 is executed using as input the response 255 and the query 215. In an example, the input to the first LLM 220 indicates that the response 255 is unsatisfactory (e.g., due to accuracy, factualness, relevance, completeness, etc.) to respond to the query 215. The first LLM 220, using as input the query 215 and the response 255 can generate a second preliminary response. The second preliminary response can be provided to the semantic model 230 to generate a second preliminary response embedding that can be used to query the vector database 240 to retrieve second contextual data. The second LLM 250 can be executed using as input the query 215 and the second contextual data to generate a second response. In some implementations, sending the response 255 to the first LLM 220 to repeat the process of generating a preliminary response, generating an embedding using the preliminary response, and retrieving contextual data using the embedding of the preliminary response broadens the scope of the contextual data retrieved from the vector database 240, as the first LLM 220 is not constrained by the contextual data 245 retrieved in the first cycle of the process.

The semantic model 230 can be executed using as input the response 255. In this way, the process can be repeated, with the response 255 being treated as a second preliminary response. The semantic model 230 can be executed using as input the response 255 to generate a second preliminary response embedding that can be used to query the vector database 240 to retrieve second contextual data. The second LLM 250 can be executed using as input the query 215 and the second contextual data to generate a second response. In some implementations, sending the response 255 to the semantic model 230 to repeat the process of generating a preliminary response, generating an embedding using the preliminary response, and retrieving contextual data using the embedding of the preliminary response adds specificity to the contextual data retrieved from the vector database 240, as the response 255, informed by the contextual data 245, is more specific than the query 215.

Responses generated by the second LLM 250 can be continuously evaluated and refined by sending them to the first LLM 220 and/or the semantic model 230 to add generality and/or specificity, respectively. Once a response generated by the second LLM 250 exceeds a predetermined score threshold, such as the predetermined accuracy score threshold, the evaluation model 260 can provide that response to the user device 210. In this way, the different portions of the process of generating a preliminary response, generating an embedding using the preliminary response, and retrieving contextual data using the embedding of the preliminary response can be leveraged to improve the response 255.

In some implementations, the query 215 is provided to the semantic model 230 as input to generate a query embedding that is used to query the vector database 240 to retrieve additional contextual data. In some implementations, the additional contextual data can be included in the contextual data 245 that is provided to the second LLM 250 as input. In some implementations, the additional contextual data is provided to the second LLM 250 to generate an additional response.

In some implementations, a plurality of responses are generated using different combinations of contextual data retrieved as discussed herein. In some implementations, the first LLM 220 generates a plurality of preliminary responses for a received input to generate a plurality of preliminary response embeddings using the semantic model 230, querying the vector database 240 using the plurality of preliminary response embeddings to retrieve additional contextual data (e.g., a plurality of sets of contextual data), and executing the second LLM 250 using as input query 215 and the additional contextual data to generate a plurality of responses to the query 215. The plurality of responses can be evaluated using the evaluation model 260. In some implementations, the evaluation model 260 ranks the plurality of responses to determine a response to provide to the user device 210. In this way, the evaluation model 260 can compare responses generated using different cycles for adding generality and/or specificity, responses generated in batches by the first LLM 220 and/or the second LLM 250, and responses generated using the query 215 to generate an embedding to retrieve contextual data. Based on the ranking of the plurality of responses, the system 200 can implement different paths for response generation to increase an efficiency of the system 200. In an example, the evaluation model 260 determines that the most highly-ranked responses were generated using an initial cycle, a cycle to increase generality, and then a cycle to increase specificity, where a cycle refers to the process of generating a preliminary response, generating an embedding using the preliminary response, and retrieving contextual data to generate a response. In this example, the system 200 can apply the same approach to future queries to increase an efficiency of reaching acceptable responses.

In some implementations, the contextual data 245 can be evaluated directly to determine whether the response 255 is acceptable. In some implementations, the second LLM 250 generates the response 255 to include a response to the query 215 as well as an evaluation of the contextual data 245. In some implementations, the response 255 includes a relevance score for the contextual data 245. The evaluation model 260 can determine whether the relevance score is above a predetermined threshold. If the relevance score for the contextual data 245 is above a predetermined relevance threshold, the evaluation model 260 can provide the response 255 to the user device to be displayed via a user interface. If the relevance score is below the predetermined relevance threshold, the evaluation model 260 can cause additional processing to be applied to the response 255, as discussed herein. In this way, the contextual data 245 used to generate the response 255, as well as the response 255, can be evaluated to determine whether the response 255 is acceptable. In some implementations, the contextual data 245 is ranked to determine what of the contextual data 245 to provide to the second LLM 250 for generating the response 255. In this way, the contextual data 245 can be filtered or selected to improve the response 255.

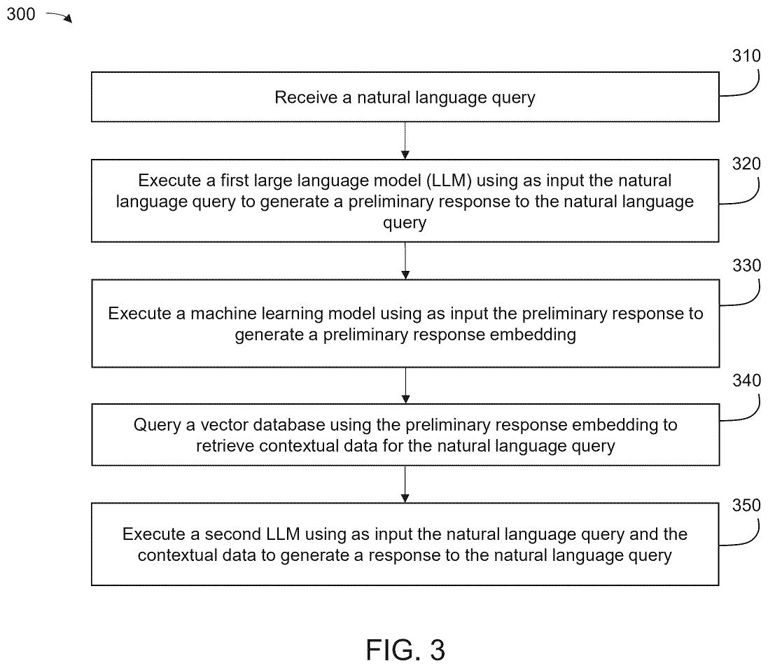

FIG. 3 illustrates an example method for two-step RAG, in accordance with an implementation. The method 300 can be performed by a data processing system (e.g., the natural language processing system 102, the computing device 106, and/or the computing device 106, each shown and described with reference to FIG. 1, a server system, etc.). The method 300 may include more or fewer operations and the operations may be performed in any order. Performance of the method 300 may enable the data processing system to generate embeddings for and implement RAG using a vector database. The method 300 can be performed by one or more components of the system 200.

At operation 310, a natural language query is received. The natural language query may be in the form of a question. The natural language query may be directed to domain data of a domain. In an example, the natural language query is received by a chatbot of a company, where the domain data is data regarding the company's products.

At operation 320, a first LLM is executed using as input the natural language query to generate a preliminary response to the natural language query. The first LLM may be fine-tuned using the domain data of the domain. In this way, the preliminary response may be more accurate and/or relevant than if the first LLM were not fine-tuned using the domain data. The preliminary response may include text responding to the natural language query.

At operation 330, a machine learning model is executed using as input the preliminary response to generate a preliminary response embedding. The machine learning model may be a semantic model. The preliminary response embedding may be a vector representing features of the preliminary response.

At operation 340, a vector database is queried using the preliminary response embedding to retrieve contextual data for the natural language query. In some implementations, the method 300 includes executing the machine learning model using as input domain data to generate the vector database. In this way, the embeddings in the vector database have a common encoding with the preliminary response embedding, as they were both generated using the same machine learning model.

At operation 350, a second LLM is executed using as input the natural language query and the contextual data to generate a response to the natural language query. In some implementations, the first LLM and the second LLM are the same LLM. In some implementations, the first LLM is an instance of the LLM that is fine-tuned using the domain data and the second LLM is not fine-tuned using the domain data. In this way, the preliminary response is made more accurate while the response is limited to the contextual data to prevent leakage of the domain data, as discussed herein.

In some implementations, the method 300 includes executing the first LLM using the domain data used to generate the vector database. In some implementations, the method 300 includes executing, by the one or more processors, an evaluation model using as input the response to determine an accuracy score for the response. Based on the accuracy score being below a predetermined threshold, the method 300 can include one or more of transmitting the response to a user device, executing the first LLM using as input the natural language query and the response, and executing the machine learning model using as input the response to generate a response embedding.

In some implementations, the method 300 includes using the first LLM to add generality to the response. The method 300 can include executing, by the one or more processors, the first LLM using as input the natural language query and the response to generate a second preliminary response, executing, by the one or more processors, the machine learning model using as input the second preliminary response to generate a second preliminary response embedding, querying, by the one or more processors, the vector database using the second preliminary response embedding to retrieve second contextual data, and executing, by the one or more processors, the second LLM using as input the natural language query and the second contextual data.

In some implementations, the method 300 includes using the machine learning model to add specificity to the response. The method 300 can include executing the machine learning model using as input the response to generate a response embedding, querying, by the one or more processors, the vector database using the response embedding to retrieve second contextual data, and executing the second LLM using as input the natural language query and the second contextual data.

In some implementations, the method 300 includes using the natural language query to retrieve additional contextual data for the second LLM. The method 300 can include executing the machine learning model using as input the natural language query to generate a natural language query embedding and querying, by the one or more processors, the vector database using the natural language query embedding to retrieve additional contextual data for the natural language query, where executing the second LLM uses as input the contextual data and the additional contextual data.

In some implementations, the method includes evaluating the contextual data. In some implementations, the second LLM evaluates the contextual data. In some implementations, the response to the natural language query includes a relevance score for the contextual data, and the method 300 includes determining the relevance score is above a predetermined threshold, and displaying, via a user interface, the response based on the relevance score being above the predetermined threshold.

In some implementations, the method 300 is performed using a plurality of preliminary responses and/or responses at different stages of the method. In some implementations, the method 300 includes receiving a plurality of preliminary responses, executing the machine learning model using as input the plurality of preliminary responses to generate a plurality of preliminary response embeddings, querying the vector database using the plurality of preliminary response embeddings to retrieve additional contextual data for the natural language query, and executing a second LLM using as input the natural language query and the additional contextual data to generate a plurality of responses to the natural language query.

Aspects of the present disclosure are directed to a method including receiving, by one or more processors, a natural language query, executing, by the one or more processors, a first large language model (LLM) using as input the natural language query to generate a preliminary response to the natural language query, executing, by the one or more processors, a machine learning model using as input the preliminary response to generate a preliminary response embedding, querying, by the one or more processors, a vector database using the preliminary response embedding to retrieve contextual data for the natural language query, and executing, by the one or more processors, a second LLM using as input the natural language query and the contextual data to generate a response to the natural language query.

In some implementations, the method includes executing, by the one or more processors, the machine learning model using as input domain data to generate the vector database. In some implementations, the method includes fine-tuning, by the one or more processors, the first LLM using domain data used to generate the vector database.

In some implementations, the method includes executing, by the one or more processors, an evaluation model using as input the response to determine an accuracy score for the response, and based on the accuracy score being below a predetermined threshold, performing one or more of transmitting, by the one or more processors, the response to a user device, executing, by the one or more processors, the first LLM using as input the natural language query and the response, and executing, by the one or more processors, the machine learning model using as input the response to generate a response embedding.

In some implementations, the method includes executing, by the one or more processors, the first LLM using as input the natural language query and the response to generate a second preliminary response, executing, by the one or more processors, the machine learning model using as input the second preliminary response to generate a second preliminary response embedding, and querying, by the one or more processors, the vector database using the second preliminary response embedding to retrieve second contextual data, and executing, by the one or more processors, the second LLM using as input the natural language query and the second contextual data.

In some implementations, the method includes executing, by the one or more processors, the machine learning model using as input the response to generate a response embedding, querying, by the one or more processors, the vector database using the response embedding to retrieve second contextual data, and executing, by the one or more processors, the second LLM using as input the natural language query and the second contextual data.

In some implementations, the first LLM and the second LLM are the same LLM.

In some implementations, the method includes executing, by the one or more processors, the machine learning model using as input the natural language query to generate a natural language query embedding, and querying, by the one or more processors, the vector database using the natural language query embedding to retrieve additional contextual data for the natural language query, wherein executing, by the one or more processors, the second LLM includes executing, by the one or more processors, the second LLM using as input the contextual data and the additional contextual data.

In some implementations, the response to the natural language query includes a relevance score for the contextual data, and the method further includes determining, by the one or more processors, whether the relevance score is above a predetermined threshold, and displaying, by the one or more processors, via a user interface, the response based on the relevance score being above the predetermined threshold.

In some implementations, the method includes receiving, by the one or more processors, a plurality of preliminary responses, executing, by the one or more processors, the machine learning model using as input the plurality of preliminary responses to generate a plurality of preliminary response embeddings, querying, by the one or more processors, the vector database using the plurality of preliminary response embeddings to retrieve additional contextual data for the natural language query, and executing, by the one or more processors, a second LLM using as input the natural language query and the additional contextual data to generate a plurality of responses to the natural language query.

Aspects of the present disclosure are directed to a system including one or more processors, and one or more non-transitory, computer-readable media including instructions which, when executed by the one or more processors, cause the one or more processors to receive a natural language query, execute a first large language model (LLM) using as input the natural language query to generate a preliminary response to the natural language query, execute a machine learning model using as input the preliminary response to generate a preliminary response embedding, query a vector database using the preliminary response embedding to retrieve contextual data for the natural language query, and execute a second LLM using as input the natural language query and the contextual data to generate a response to the natural language query.

In some implementations, the instructions cause the one or more processors to execute the machine learning model using as input domain data to generate the vector database. In some implementations, the instructions cause the one or more processors to fine tune the first LLM using domain data used to generate the vector database.

In some implementations, the instructions cause the one or more processors to execute an evaluation model using as input the response to determine an accuracy score for the response, and based on the accuracy score being below a predetermined threshold, perform one or more of transmit the response to a user device, execute the first LLM using as input the natural language query and the response, and execute the machine learning model using as input the response to generate a response embedding.

In some implementations, the instructions cause the one or more processors to execute the first LLM using as input the natural language query and the response to generate a second preliminary response, execute the machine learning model using as input the second preliminary response to generate a second preliminary response embedding, and query the vector database using the second preliminary response embedding to retrieve second contextual data, and execute the second LLM using as input the natural language query and the second contextual data.

In some implementations, the instructions cause the one or more processors to execute the machine learning model using as input the response to generate a response embedding, query the vector database using the response embedding to retrieve second contextual data, and execute the second LLM using as input the natural language query and the second contextual data.

In some implementations, the first LLM and the second LLM are the same LLM.

In some implementations, the instructions cause the one or more processors to execute the machine learning model using as input the natural language query to generate a natural language query embedding, and query the vector database using the natural language query embedding to retrieve additional contextual data for the natural language query, wherein executing, by the one or more processors, the second LLM includes executing, by the one or more processors, the second LLM using as input the contextual data and the additional contextual data.

Aspects of the present disclosure are directed to one or more non-transitory, computer-readable media including instructions which, when executed by one or more processors, cause the one or more processors to receive a natural language query, execute a first large language model (LLM) using as input the natural language query to generate a preliminary response to the natural language query, execute a machine learning model using as input the preliminary response to generate a preliminary response embedding, query a vector database using the preliminary response embedding to retrieve contextual data for the natural language query, and execute a second LLM using as input the natural language query and the contextual data to generate a response to the natural language query.

In some implementations, the instructions further cause the one or more processors to execute an evaluation model using as input the response to determine an accuracy score for the response, and based on the accuracy score being below a predetermined threshold, perform one or more of transmit the response to a user device, execute the first LLM using as input the natural language query and the response, and execute the machine learning model using as input the response to generate a response embedding.

### Large Language Models and Generative Artificial Intelligence

Large language models can be used to implement or enhance aspects described herein. As discussed above, replays, logs, or other data of user interactions with the digital experience can be captured. Such data can be provided as input to a large language model with a prompt to summarize what occurred. Such a summary can be provided as part of the remediation (e.g., to developers to better understand the problem). Further, the large language model can be prompted to identify designs or other changes that may be implemented to address the struggle. In addition to or instead of designs, the large language model may be configured to (e.g., with appropriate prompts and contacts) generate code or instructions (or changes to code or instructions) that address the struggle. A large language model may be used to generate user-specific and struggle-specific messages to the user (e.g., in relation to the above communications).

### Computing Environment

FIG. 4 discloses a computing environment 400 in which aspects of the present disclosure may be implemented. A computing environment 400 is a set of one or more virtual or physical computers 410 that individually or in cooperation achieve tasks, such as implementing one or more aspects described herein. The computers 410 have components that cooperate to cause output based on input. Example computers 410 include desktops, servers, mobile devices (e.g., smart phones and laptops), payment terminals, wearables, virtual/augmented/expanded reality devices, spatial computing devices, virtualized devices, other computers, or combinations thereof. In particular example implementations, the computing environment 400 includes at least one physical computer.

The computing environment 400 may specifically be used to implement one or more aspects described herein. In some examples, one or more of the computers 410 may be implemented as a user device, such as a mobile device, and others of the computers 410 may be used to implement aspects of a machine learning framework useable to train and deploy models exposed to the mobile device or provide other functionality, such as through exposed application programming interfaces.

The computing environment 400 can be arranged in any of a variety of ways. The computers 410 can be local to or remote from other computers 410 of the environment 400. The computing environment 400 can include computers 410 arranged according to client-server models, peer-to-peer models, edge computing models, other models, or combinations thereof.

In many examples, the computers 410 are communicatively coupled with devices internal or external to the computing environment 400 via a network 490. The network 490 is a set of devices that facilitate communication from a sender to a destination, such as by implementing communication protocols. Example networks 490 include local area networks, wide area networks, intranets, or the Internet.

In some implementations, computers 410 can be general-purpose computing devices (e.g., consumer computing devices). In some instances, via hardware or software configuration, computers 410 can be special purpose computing devices, such as servers able to practically handle large amounts of client traffic, machine learning devices able to practically train machine learning models, data stores able to practically store and respond to requests for large amounts of data, other special purposes computers, or combinations thereof. The relative differences in capabilities of different kinds of computing devices can result in certain devices specializing in certain tasks. For instance, a machine learning model may be trained on a powerful computing device and then stored on a relatively lower powered device for use.

Many example computers 410 include one or more processors 412, memory 414, and one or more interfaces 418. Such components can be virtual, physical, or combinations thereof.

The one or more processors 412 are components that execute instructions, such as instructions that obtain data, process the data, and provide output based on the processing. The one or more processors 412 often obtain instructions and data stored in the memory 414. The one or more processors 412 can take any of a variety of forms, such as central processing units, graphics processing units, coprocessors, tensor processing units, artificial intelligence accelerators, microcontrollers, microprocessors, application-specific integrated circuits, field programmable gate arrays, other processors, or combinations thereof. In example implementations, the one or more processors 412 include at least one physical processor implemented as an electrical circuit. Example providers processors 412 include INTEL, AMD, QUALCOMM, TEXAS INSTRUMENTS, and APPLE.

The memory 414 is a collection of components configured to store instructions 416 and data for later retrieval and use. The instructions 416 can, when executed by the one or more processors 412, cause execution of one or more operations that implement aspects described herein. In many examples, the memory 414 is a non-transitory computer-readable medium, such as random access memory, read only memory, cache memory, registers, portable memory (e.g., enclosed drives or optical disks), mass storage devices, hard drives, solid state drives, other kinds of memory, or combinations thereof. In certain circumstances, transitory memory 414 can store information encoded in transient signals.

The one or more interfaces 418 are components that facilitate receiving input from and providing output to something external to the computer 410, such as visual output components (e.g., displays or lights), audio output components (e.g., speakers), haptic output components (e.g., vibratory components), visual input components (e.g., cameras), auditory input components (e.g., microphones), haptic input components (e.g., touch or vibration sensitive components), motion input components (e.g., mice, gesture controllers, finger trackers, eye trackers, or movement sensors), buttons (e.g., keyboards or mouse buttons), position sensors (e.g., terrestrial or satellite-based position sensors, such as those using the Global Positioning System), other input components, or combinations thereof (e.g., a touch sensitive display). The one or more interfaces 418 can include components for sending or receiving data from other computing environments or electronic devices, such as one or more wired connections (e.g., Universal Serial Bus connections, THUNDERBOLT connections, ETHERNET connections, serial ports, or parallel ports) or wireless connections (e.g., via components configured to communicate via radiofrequency signals, such as WI-FI, cellular, BLUETOOTH, ZIGBEE, or other protocols). One or more of the one or more interfaces 418 can facilitate connection of the computing environment 400 to a network 490.

The computers 410 can include any of a variety of other components to facilitate performance of operations described herein. Example components include one or more power units (e.g., batteries, capacitors, power harvesters, or power supplies) that provide operational power, one or more busses to provide intra-device communication, one or more cases or housings to encase one or more components, other components, or combinations thereof.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries (e.g., libraries that provide functions for obtaining, processing, and presenting data), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein, such as intelligent code completion tools (e.g., INTELLISENSE) and artificial intelligence tools (e.g., GITHUB COPILOT).

In some examples, large language models can be used to understand natural language, generate natural language, or perform other tasks. Examples of such large language models include CHATGPT by OPENAI, a LLAMA model by META, a CLAUDE model by ANTHROPIC, others, or combinations thereof. Such models can be fine-tuned on relevant data using any of a variety of techniques to improve the accuracy and usefulness of the answers. The models can be run locally on server or client devices or accessed via an application programming interface. Some of those models or services provided by entities responsible for the models may include other features, such as speech-to-text features, text-to-speech, image analysis, research features, and other features, which may also be used as applicable.

### Machine Learning Framework

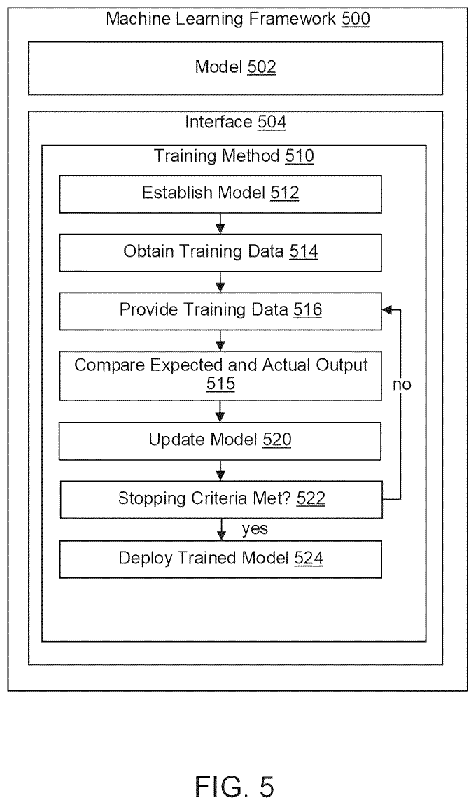

FIG. 5 illustrates an example machine learning framework 500 that techniques described herein may benefit from. A machine learning framework 500 is a collection of software and data that implements artificial intelligence trained to provide output, such as predictive data, based on input. Examples of artificial intelligence that can be implemented with machine learning ways include neural networks (including recurrent neural networks), language models (including so-called “large language models”), generative models, natural language processing models, adversarial networks, decision trees, Markov models, support vector machines, genetic algorithms, others, or combinations thereof. A person of skill in the art, having the benefit of this disclosure, will understand that these artificial intelligence implementations need not be equivalent to each other and may instead select from among them based on the context in which they will be used. Machine learning frameworks 500 or components thereof are often built or refined from existing frameworks, such as TENSORFLOW by GOOGLE, INC. or PYTORCH by the PYTORCH community.

The machine learning framework 500 can include one or more models 502 that are the structured representation of learning and an interface 504 that supports use of the model 502.

The model 502 can take any of a variety of forms. In many examples, the model 502 includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model 502 can include a representation of memory (e.g., providing long short-term memory functionality). Where the set includes more than one model 502, the models 502 can be linked, cooperate, or compete to provide output.

The interface 504 can include software procedures (e.g., defined in a library) that facilitate the use of the model 502, such as by providing a way to establish and interact with the model 502. For instance, the software procedures can include software for receiving input, preparing input for use (e.g., by performing vector embedding, such as using Word2Vec, BERT, or another technique), processing the input with the model 502, providing output, training the model 502, performing inference with the model 502, fine tuning the model 502, other procedures, or combinations thereof.

In an example implementation, interface 504 can be used to facilitate a training method 510 that can include operation 512. Operation 512 includes establishing a model 502, such as initializing a model 502. The establishing can include setting up the model 502 for further use (e.g., by training or fine tuning). The model 502 can be initialized with values. In examples, the model 502 can be pretrained. Operation 514 can follow operation 512. Operation 514 includes obtaining training data. In many examples, the training data includes pairs of input and desired output given the input. In supervised or semi-supervised training, the data can be prelabeled, such as by human or automated labelers. In unsupervised learning the training data can be unlabeled. The training data can include validation data used to validate the trained model 502. Operation 516 can follow operation 514. Operation 516 includes providing a portion of the training data to the model 502. This can include providing the training data in a format usable by the model 502. The framework 500 (e.g., via the interface 504) can cause the model 502 to produce an output based on the input. Operation 515 can follow operation 516. Operation 515 includes comparing the expected output with the actual output. In an example, this can include applying a loss function to determine the difference between expected and actual. This value can be used to determine how training is progressing. Operation 520 can follow operation 515. Operation 520 includes updating the model 502 based on the result of the comparison. This can take any of a variety of forms depending on the nature of the model 502. Where the model 502 includes weights, the weights can be modified to increase the likelihood that the model 502 will produce correct output given an input. Depending on the model 502, backpropagation or other techniques can be used to update the model 502. Operation 522 can follow operation 520. Operation 522 includes determining whether a stopping criterion has been reached, such as based on the output of the loss function (e.g., actual value or change in value over time). In addition to, or instead, whether the stopping criterion has been reached can be determined based on a number of training epochs that have occurred or an amount of training data that has been used. In some examples, satisfaction of the stopping criterion can include If the stopping criterion has not been satisfied, the flow of the method can return to operation 514. If the stopping criterion has been satisfied, the flow can move to operation 522. Operation 522 includes deploying the trained model 502 for use in production, such as providing the trained model 502 with real-world input data and produce output data used in a real-world process. The model 502 can be stored in memory 414 of at least one computer 410, or distributed across memories of two or more such computers 410 for production of output data (e.g., predictive data).

### Application of Techniques

Techniques herein may be applicable to improving technological processes of a financial institution, such as technological aspects of actions (e.g., resisting fraud, entering loan agreements, transferring financial instruments, or facilitating payments). Although technology may be related to processes performed by a financial institution, unless otherwise explicitly stated, claimed inventions are not directed to fundamental economic principles, fundamental economic practices, commercial interactions, legal interactions, or other patent ineligible subject matter without something significantly more.

Where implementations involve personal or corporate data, that data can be stored in a manner consistent with relevant laws and with a defined privacy policy. In certain circumstances, the data can be decentralized, anonymized, or fuzzed to reduce the amount of accurate private data that is stored or accessible at a particular computer. The data can be stored in accordance with a classification system that reflects the level of sensitivity of the data and that encourages human or computer handlers to treat the data with a commensurate level of care.

Where implementations involve machine learning, machine learning can be used according to a defined machine learning policy. The policy can encourage training of a machine learning model with a diverse set of training data. Further, the policy can encourage testing for, and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions based on protected characteristics.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method comprising:
receiving, by one or more processors, a natural language query;
executing, by the one or more processors, a first large language model (LLM) using as input the natural language query to generate a preliminary response to the natural language query;
executing, by the one or more processors, a machine learning model using as input the preliminary response to generate a preliminary response embedding;
querying, by the one or more processors, a vector database using the preliminary response embedding to retrieve contextual data for the natural language query; and
executing, by the one or more processors, a second LLM using as input the natural language query and the contextual data to generate a response to the natural language query.

2. The method of claim 1, further comprising executing, by the one or more processors, the machine learning model using as input domain data to generate the vector database.

3. The method of claim 1, further comprising fine-tuning, by the one or more processors, the first LLM using domain data used to generate the vector database.

4. The method of claim 1, further comprising:
executing, by the one or more processors, an evaluation model using as input the response to determine an accuracy score for the response; and
based on the accuracy score being below a predetermined threshold, performing one or more of:
transmitting, by the one or more processors, the response to a user device;
executing, by the one or more processors, the first LLM using as input the natural language query and the response; or
executing, by the one or more processors, the machine learning model using as input the response to generate a response embedding.

5. The method of claim 1, further comprising:
executing, by the one or more processors, the first LLM using as input the natural language query and the response to generate a second preliminary response;
executing, by the one or more processors, the machine learning model using as input the second preliminary response to generate a second preliminary response embedding;
querying, by the one or more processors, the vector database using the second preliminary response embedding to retrieve second contextual data; and
executing, by the one or more processors, the second LLM using as input the natural language query and the second contextual data.

6. The method of claim 1, further comprising:
executing, by the one or more processors, the machine learning model using as input the response to generate a response embedding;
querying, by the one or more processors, the vector database using the response embedding to retrieve second contextual data; and
executing, by the one or more processors, the second LLM using as input the natural language query and the second contextual data.

7. The method of claim 1, wherein the first LLM and the second LLM are the same LLM.

8. The method of claim 1, further comprising:
executing, by the one or more processors, the machine learning model using as input the natural language query to generate a natural language query embedding;
and querying, by the one or more processors, the vector database using the natural language query embedding to retrieve additional contextual data for the natural language query, wherein executing, by the one or more processors, the second LLM includes executing, by the one or more processors, the second LLM using as input the contextual data and the additional contextual data.

9. The method of claim 1, wherein the response to the natural language query includes a relevance score for the contextual data, and wherein the method further comprises:
determining, by the one or more processors, whether the relevance score is above a predetermined threshold; and
displaying, by the one or more processors, via a user interface, the response based on the relevance score being above the predetermined threshold.

10. The method of claim 1, further comprising:
receiving, by the one or more processors, a plurality of preliminary responses;
executing, by the one or more processors, the machine learning model using as input the plurality of preliminary responses to generate a plurality of preliminary response embeddings;
querying, by the one or more processors, the vector database using the plurality of preliminary response embeddings to retrieve additional contextual data for the natural language query; and
executing, by the one or more processors, a second LLM using as input the natural language query and the additional contextual data to generate a plurality of responses to the natural language query.

11. A system comprising:
one or more processors; and
one or more non-transitory, computer-readable media including instructions which, when executed by the one or more processors, cause the one or more processors to:
receive a natural language query;
execute a first large language model (LLM) using as input the natural language query to generate a preliminary response to the natural language query;
execute a machine learning model using as input the preliminary response to generate a preliminary response embedding;
query a vector database using the preliminary response embedding to retrieve contextual data for the natural language query; and
execute a second LLM using as input the natural language query and the contextual data to generate a response to the natural language query.

12. The system of claim 11, wherein the instructions cause the one or more processors to execute the machine learning model using as input domain data to generate the vector database.

13. The system of claim 11, wherein the instructions cause the one or more processors to fine tune the first LLM using domain data used to generate the vector database.

14. The system of claim 11, wherein the instructions cause the one or more processors to:
execute an evaluation model using as input the response to determine an accuracy score for the response; and
based on the accuracy score being below a predetermined threshold, perform one or more of:
transmit the response to a user device;
execute the first LLM using as input the natural language query and the response; or
execute the machine learning model using as input the response to generate a response embedding.

15. The system of claim 11, wherein the instructions cause the one or more processors to:
execute the first LLM using as input the natural language query and the response to generate a second preliminary response;
execute the machine learning model using as input the second preliminary response to generate a second preliminary response embedding;
query the vector database using the second preliminary response embedding to retrieve second contextual data; and
execute the second LLM using as input the natural language query and the second contextual data.

16. The system of claim 11, wherein the instructions cause the one or more processors to:
execute the machine learning model using as input the response to generate a response embedding;
query the vector database using the response embedding to retrieve second contextual data; and
execute the second LLM using as input the natural language query and the second contextual data.

17. The system of claim 11, wherein the first LLM and the second LLM are the same LLM.

18. The system of claim 11, wherein the instructions cause the one or more processors to:
execute the machine learning model using as input the natural language query to generate a natural language query embedding; and
query the vector database using the natural language query embedding to retrieve additional contextual data for the natural language query, wherein executing, by the one or more processors, the second LLM includes executing, by the one or more processors, the second LLM using as input the contextual data and the additional contextual data.

19. One or more non-transitory, computer-readable media including instructions which, when executed by one or more processors, cause the one or more processors to:
receive a natural language query;
execute a first large language model (LLM) using as input the natural language query to generate a preliminary response to the natural language query;
execute a machine learning model using as input the preliminary response to generate a preliminary response embedding;
query a vector database using the preliminary response embedding to retrieve contextual data for the natural language query; and
execute a second LLM using as input the natural language query and the contextual data to generate a response to the natural language query.

20. The non-transitory, computer-readable media of claim 19, wherein the instructions further cause the one or more processors to:
execute an evaluation model using as input the response to determine an accuracy score for the response; and
based on the accuracy score being below a predetermined threshold, perform one or more of:
transmit the response to a user device;
execute the first LLM using as input the natural language query and the response; or
execute the machine learning model using as input the response to generate a response embedding.
